(19) United States
(12) Patent Application Publication
(10) Pub. No.: US 2018/0089742 A1
(43) Pub. Date: Mar. 29, 2018

(54) Dynamic Website Personalization and Data Sharing

(71) Applicant: PAYPAL, INC., San Jose, CA (US)

(72) Inventors: Srivathsan Narasimhan, Saratoga, CA (US); Girish Sharma, San Jose, CA (US)

(21) Appl. No.: 15/275,195

(22) Filed: Sep. 23, 2016

(51) Int. Cl. G06Q 30/06; H04L 29/08; G06Q 20/40

(52) U.S. Cl. CPC G06Q 30/0633; H04L 67/42; G06Q 20/401; H04L 67/18

(57) ABSTRACT

While website or other user content is often static, dynamic content personalization may allow for a better user experience. One way to personalize content, such as web content, is to gather information on a user, and then use that information to augment content. This approach is limited, however, in that a smaller website operator may have little or no data on its users, who may be infrequent. By making use of data collection modules, however, personalization data can be gathered from a number of different sources. Correlation of user identity using a correlation database may then be performed to determine that a user of one site is the same as the user of another site (even if the user presents different login credentials on those sites). This allows personalization data to be leveraged at scale and presentation of dynamic content opportunities, improving content and providing a more useful experience.

### TECHNICAL FIELD

This disclosure relates to the field of dynamic content personalization. More particularly, this disclosure also relates to data sharing and user identification correlation techniques.

### BRIEF DESCRIPTION OF THE DRAWINGS

FIG. 1 illustrates a block diagram of a system users, various data sources with which the users may interact, a personalization server, and a personalization database that is configured to store personalization information gathered from the various data sources, including websites, via embedded code, according to some embodiments.

FIG. 2 illustrates a block diagram of a data source such as those depicted in FIG. 1, according to some embodiments.

FIG. 3 illustrates a block diagram of a personalization server, according to some embodiments.

FIG. 4 illustrates a block diagram of a correlation table that stores information indicating different user identifiers that correspond to a same user or device, according to some embodiments.

FIG. 5 illustrates a block diagram of a user action table that stores details regarding user actions taken on a variety of data sources, including websites, according to some embodiments.

FIG. 6A is a flow diagram illustrating particular operations that relate to constructing modified personalization data based on other personalization data, according to some embodiments.

FIG. 6B is a block diagram further illustrating certain aspects of data personalization relative to a specific example, according to some embodiments.

FIG. 7 is a block diagram of one embodiment of a computer readable medium.

FIG. 8 is a block diagram of one embodiment of a system.

### DETAILED DESCRIPTION

Internet and web users can achieve greater efficiency in online transactions when content is personalized. A web page, mobile application, or other application that includes dynamic content based on particular information about a user (or perhaps one or more other similar users) may be more useful than content of a web page or application that remains essentially the same regardless of the identity of the viewer.

In the case of content personalization, scale and size can provide distinct advantages to certain website or application operators, who may have vast user bases and a similarly large amount of personal information at their disposal. (Note that Small and medium website operators, however, may not be able to easily offer personalized experiences due to lack of scale and/or lack of frequent transactions. A small online business might see a particular user once a year, for example, while a larger online business could see that same user on its site several times a month, thus providing the larger business the opportunity to know their customer at a detailed level higher level and thus provide greater content customization. Accordingly, in various instances, seeing a particular identity allows an observing system to know the entity relates to a specific entity profile, and the observing system knows more than just information gathered about a single interaction instance.

Trying to collect usage or other personalization data from numerous smaller website or application operators can be a challenging task, however. Many such websites may not obtain or may not retain much personalization data, if any at all. These disparate websites may also be programmed using different formats, languages, databases, or other technical elements that would complicate implementation of a solution seeking to gather data from the sites, as such a solution might have to be integrated differently into the fabric of such a wide variety of sites. Small businesses may not have the resources and knowhow to build and maintain this infrastructure and over time, this can be a differentiating existential threat to them.

Pre-existing functionality that is present on websites or in other applications can be leveraged to collect personalization data at a centralized location in some instances, however. A javascript file (or other data collection code), for example, that is loaded by different websites or applications can be programmed to harvest data. An entity (such as a provider of third party code to a website or application) that has a more detailed view about different user identities can make correlations between user identities on different sites that may actually be the same user or same device. (For example, if a user logs into a first website using a first email address, but logs into a different website using a different email address, these two different user identifiers can be correlated to one another, sometimes using additional data. Likewise, a user with two different identifiers for a mobile application and another platform can also have those identifiers correlated). Digital payment related code (as could be used on a web site, mobile application, or other application), such as that utilized by a company like PAYPAL, may be a particularly useful vehicle for achieving the above tasks. (Note that one advantage provided via the technological niche occupied by a payments company, in various embodiments, is that abuse of services may be severely reduced, since bad actors like trolls and other fake users may have to make a purchase if they want to introduce false or misleading data to a system. This is a problem that plagues other recommendation systems that are not based on payments/purchase.)

This specification includes references to “one embodiment,” “some embodiments,” or “an embodiment.” The appearances of these phrases do not necessarily refer to the same embodiment. Particular features, structures, or characteristics may be combined in any suitable manner consistent with this disclosure.

“First,” “Second,” etc. As used herein, these terms are used as labels for nouns that they precede, and do not necessarily imply any type of ordering (e.g., spatial, temporal, logical, cardinal, etc.).

Various components may be described or claimed as “configured to” perform a task or tasks. In such contexts, “configured to” is used to connote structure by indicating that the components include structure (e.g., stored logic) that performs the task or tasks during operation. As such, the component can be said to be configured to perform the task even when the component is not currently operational (e.g., is not on). Reciting that a component is “configured to” perform one or more tasks is expressly intended not to invoke 35 U.S.C. § 112(f) for that component.

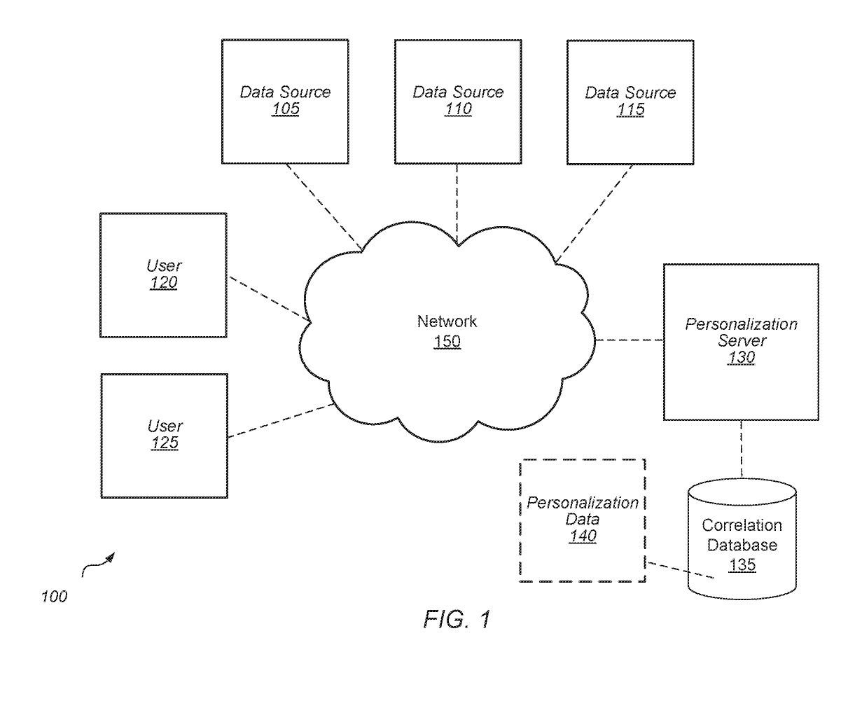

Turning to FIG. 1, a block diagram of a system 100 is shown. In this diagram, system 100 includes data sources 105, 110, and 115, users 120 and 125, personalization server 130, correlation database 135, and network 150. Users 120 and 125 (as well as other users not shown) may access content on any of data sources 105, 110, and 115. Note that data sources 105, 110, and 115 may each be, in any number of embodiments, a website, a mobile or desktop application, an application that provides an interface to a device allowing purchases (e.g., something part of the Internet of Things, such as a smart appliance, network-enabled vending machine, etc.), or a voice-enabled purchasing service. In various examples below, this disclosure may discuss acquiring data from a website or using data within the context of a website. It is important to note that while these examples are provided for ease of explanation, and that data acquisition and data use (e.g., personalization data) can be performed relative to a number of different applications and interfaces. Thus, while data sources 105, 110, and 115 are websites in various embodiments, in other embodiments, one or more of these data sources is an application hosted on a platform other than a web server.

Data sources 105, 110, and 115 may in turn be in communication with personalization server 130, as further described herein. (Note that users 120 and 125, as well as data sources 105, 110, and 115 each have one or more corresponding computing devices associated with them in various embodiment, and that any action said to be taken by one of these entities can be understood to be performed partly or wholly by such a computing device in various embodiments.)

Users 120 and 125 may engage in transactions via data sources 105, 110, and 115. Accordingly, each of data sources 105, 110, and 115 may be associated with one or more computer servers configured as HTTP/HTTPS servers and include one or more corresponding web pages. Systems and entities depicted in FIG. 1 may communicate with one another via network 150, which includes all or a portion of the Internet, in various embodiments.

Personalization server 130 is a computer system configured to receive personalization data from users 120 and 125 and data sources 105, 110, and 115, in the embodiment shown. This aspect will be described in greater detail below, but may include personalization data 140 being stored in correlation database 135 after receipt. Thus, personalization server 130 may have access to a variety of personalization data obtained regarding users and user actions performed on websites such as data sources 105, 110, and 115.

Personalization data 140 may include usage data indicative of one or more particular actions taken by a user on a website (such as data source 105). These actions can include, but are not limited to, adding an item to a shopping cart, hovering a cursor above a picture or description of an item, removing an item from the shopping cart, or viewing or selecting a video, still image, or other depiction of an item. Personalization data 140 can also include transaction information, such as whether a user has made a purchase of a particular item or type of item, an amount of the purchase, date of purchase, identity of transacting merchant, category code (e.g. business type) of transacting merchant, or any other transaction detail. Personalization data 140 may include similar item description and pricing information about items added to an online shopping cart at a merchant's website, but for which a sale was never completed (possibly indicating user interest in purchasing such items).

Personalization data 140 may also include a user-provided preference regarding a type of goods or services sold by a merchant (for example, a preference for silk sheets over cotton, one brand of sporting equipment over another, a particular type of media file format for download (e.g., FLAC vs. MP3), etc.) Note that in various embodiments, any personalization data obtained by personalization server 130 and stored in correlation database 135 is done with consent from users and in a manner that complies with any relevant applicable legal data privacy requirements.

Personalization data 140 that is collected by personalization server 130 can also include a location associated with a user, Thus, location data associated with a user may include a user's home address, one or more previously used shipping addresses, a business address or geographic location data (GPS coordinates, IP address, etc.) associated with one or more previous purchases (e.g., where a user's device was located when a particular previous transaction was initiated).

Personalization data 140 can include information regarding one or more other household members associated with the user. Information regarding household members associated with the user may include data about whether the user shares a home with one or more other individuals, relationship of those individuals to the user (spouse, domestic partner, unrelated roommate, child, parent, etc.), and demographic data about those individuals (see further below).

Demographic data for personalization data 140 may also be present for the user or others. This demographic data (like all items of personalization data) may be provided by a user to data source 105 with consent, in some embodiments, after which the data is then passed on to personalization server 130. This demographic data can include but is not limited to age, gender, ethnicity, national origin, etc. Thus, in accordance with the above, personalization data may include in various embodiments the following type(s) of data: financial (income, liabilities, etc.), demographic (age, gender, etc.), geographic (region, population, etc.), psychographic (lifestyles, dynamic profile, activities, opinions, attitudes, etc.), behavioral (PayPal or other service provider usage, service provider partner usage, brand loyalty, readiness to buy, event triggers to buy, etc.), social profile (friend, family graph, etc.), cohort segments (yuppie, suburban, etc.).

Further data that can be collected and included in personalization data 140 includes, in various embodiments: more detailed device fingerprinting data (e.g., see below); device sensor activity such as fitness tracking data, device usage by user (eye tracking, etc.); household entity data; social group entity data; feedback review data; merchant data about a person; financial data about a person; brand and purchase preferences for a person (e.g., brands they frequently buy or frequently avoid, etc.); and surrounding devices in proximity and the above data based on those devices (e.g., data can be collected regarding a nearby device as well). In one instance, personalization data 140 can also include determined user behavior with a mobile phone at rest and phone activity during shopping, etc. Thus, personalization data 140 may allow detection of comparison shopping by a user, for example, by searching for store locations in the offline world which can then fuel personalization. E.g., if a user's phone is detected at a Wal-Mart, a Best Buy, and a Sears within two hours, we can make an inference that the user is comparison shopping, possible for a large purchase. If personalization data 140 reveals that a purchase of a $1000 refrigerator was ultimately made at the Sears, it can be inferred that the user was comparison shopping for that particular large appliance (and that they declined to purchase from Wal-Mart or Best Buy). Personalization data 140 may also include, in some embodiments, data collected by a merchant over time by their servers that is shared with a payment provider or other entity. Such data may include information about the tenure of users (date first joined, activity of an account, frequency of purchases and/or browsing, length of account in good or bad standing, user boarding details, and other context for that merchant). Note that in some embodiments, user feedback on a purchased item may be collected at some time after purchase. This user feedback may be shared with a merchant from whom the item was purchased (or potentially another merchant) and can be used to further personalize experiences.

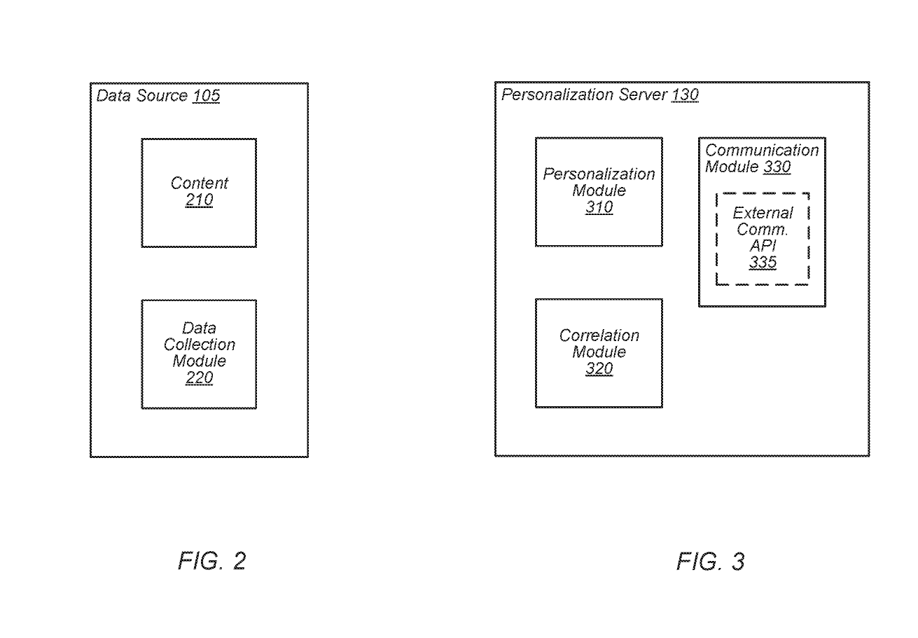

Turning to FIG. 2, a diagram of one embodiment of data source 105 is shown. In this embodiment, data source 105 may be a website, and includes content 210 and data collection module 220. Note that any other website or application, such as data sources 110 and 115, may correspond to any or all of the features described relative to data source 105 in various embodiments.

Content 210 includes one or more web pages and associated data in the embodiment shown. In other embodiments, content 210 may include content that is displayed on one or more application screens (e.g., mobile application screens, etc.). These web pages, application screens or interfaces, etc., may include sale offers for products or services that are available for purchase by users 120 and 125. The web pages may also include reviews, descriptions, user comments or testimonials, still images, video, audio, etc., regarding one or more products or services available for purchase. Content 210 may include additional data as well, such as inventory (e.g., availability) and pricing data. (Again, note that while some examples herein are described relative to a web page for ease of explanation, these examples are equally applicable to other contexts in other embodiments, such as mobile applications, a smart appliance, etc.). Further, note that in one or more instances, URL referrer data for websites may be collected as well as universal linking data for mobile applications, both may indicate which URL led to a particular page such a page in content 210. URL referrer data may be collected and included in personalization data 140 in various cases. Web tracking data, such as Google analytics, etc., that focuses on first party tracking of web usage, click through, time spent on sites, activities performed on sites (e.g. such as sites hosting content 210) may also be a significant input to personalization data 140, in various embodiments. Similar tracking can be performed for mobile applications (time spent looking at a particular screen, etc.

Data collection module 220 comprises computer instructions, in various embodiments, that are executable to collect personalization data 140. In one embodiment, data collection module 220 includes JavaScript code that is transmitted to a user as part of a web page of data source 105 (e.g., when the user views a portion of content 210). Thus, all or a portion of data collection module 220 may be included in one or more web pages transmitted to a user. Data collection module 220 can include code (precompiled or not) in other languages as well, in various embodiments, such as JAVA, PYTHON, CSS, PHP, RUBY, or C++, though data collection module 220 is not limited to these examples.

Accordingly, all or a portion of data collection module 220 may be transmitted to user 120 or 125 (e.g., within or in association with a web page), and can be executed on their local machine via a web browser, in various embodiments. Data collection module 220 therefore can collect various personalization data about a user, including user actions taken on a website, and transmit this information back to data source 105 and/or to personalization server 130, for example. In some embodiments, all or a portion of data collection module 220 may be executed by personalization server 130 to receive, access, and/or transmit personalization server. (For example, address or preference data stored in a database at personalization server 130 could be accessed by data collection module 220, in one embodiment.) Thus, data collection module 220 facilitates the collection of personalization data, and all or a portion of data collection module 220 may be executed on a server associated with data source 105, instead of merely executing locally on a user machine.

All or part of data collection module 220 can thus be transmitted to a user who is viewing items for potential purchase on a web page, and then used to track any or all user actions on that web page. Data collection module 220 may likewise be used to collect transaction data, payment data, and any other personalization data as discussed above, in various embodiments.

Turning to FIG. 3, a block diagram is shown of one embodiment of personalization server 130. In this embodiment, personalization server 130 includes personalization module 310, correlation module 320, and communication module 330.

Personalization module 310 includes instructions executable to perform operations related to personalization data in various embodiments. Personalization module 310 may therefore store, access, update, and modify personalization data (though is not limited to such functions).

Correlation module 320 includes instructions executable to perform user identification matches and make correlations between users and personalization data in various embodiments. That is, correlation module may enable personalization server 130 to determine that two different user identifications in fact correspond to a same user or device. This matching process is described in greater depth below.

Communication module 330 includes instructions executable to transmit and receive data with users 120 and 125 and data sources 105, 110, and 115 in various embodiments. External communications API 335 includes a set of exposed application programming interface (API) functions in one embodiment that allow a merchant (or other party) to request or submit personalization data to or from personalization server 130. For example, a merchant upon having a user enter a checkout (purchase) phase of the website, or upon adding an item to a shopping cart, may contact personalization server 130 through external communications API 335 to ask the server if it has any additional personalization data about the user that may be helpful to the merchant.

Note that in one embodiment, there can be a two way or three way exchange between a merchant, service provider, and/or an authorized agent of a merchant about user data. Such an exchange may feature data sent to a service provider along with a merchant request and then processed and returned with a response. Such an exchange may be a weaker signal, in some embodiments, than other data signals but can enhance a service provider's build-out of a user's personalization data.

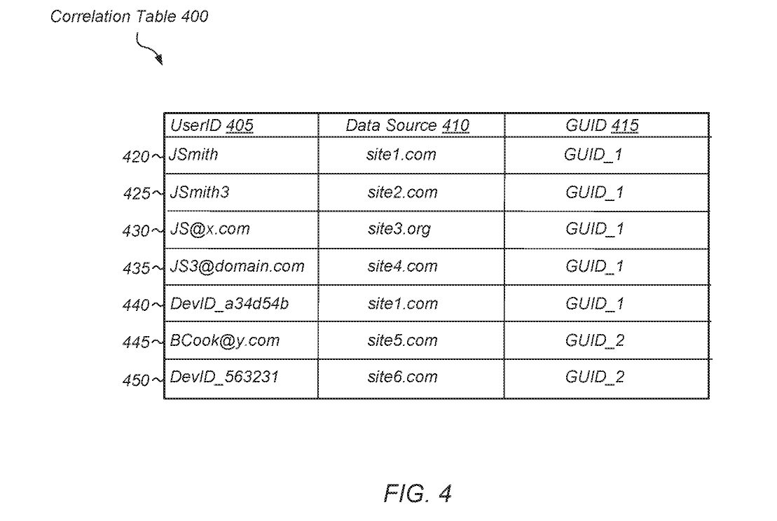

Turning to FIG. 4, a diagram of one embodiment of a correlation table is shown. Correlation table 400 may be accessed by correlation module 320, and/or stored in correlation database 135, in various embodiments.

Correlation table 400 is one example illustrating how different user identifiers may be linked with one another (indicating that two or more user identifiers correspond to a same user and/or device, for example). Other configurations and data organizations are possible, however.

As shown, correlation table 400 includes columns UserID (user identifier) 405, data source 410 (which may be a website, or may be an application hosted on another platform), and GUID (global user identifier) 415. Correlation table 400 also includes rows 420, 425, 430, 435, 440, 445, and 450.

Row 420 indicates that a user identifier of “JSmith” is known to have been used at site1.com, while row 425 shows that a user identifier of “JSmith3” has been used at site2.com. The user identifiers “JSmith” and “JSmith3” are login names for site1.com and site2.com, respectively, in this embodiment. Other types of user identifiers are also used, and include email addresses and device IDs.

Rows 430 and 435 show that two different email addresses (“JS@x.com” and “JS3@domain.com”) have been used as user identifiers at two other data sources (site3.org and site4.com, respectively). In row 440, a device identifier (“DevID_a34d54b”) has been used on site1.com. This device identifier may be a unique set of data calculated based on various hardware, software, or network characteristics of a user device. Such a user device fingerprint may be based on a combination of information including operating system type and version, media access control (MAC) address, IP address, processor type, device type, etc. Note that in some embodiments, a user ID and device ID are distinct. Further, note that device identifiers may be calculated based on many different variables in a variety of embodiments in addition to those already listed. These variables may include application(s) installed on a device and application versions; advertising identifiers; locale settings; device model numbers; memory and/or storage space; phone number and/or area code; network connection information; session ID; customer ID; and more. Further, note that personalization data (e.g. as used by a merchant website or application) could also be adjusted based on network information. For example, if a lower bit-rate connection is being used, still images or text might be provided rather than a video or animation.

As shown, each of rows 420, 425, 430, 435, and 440 have a same GUID value of “GUID_1”. Thus, while each of these rows has a different associated user identifier 405, correlation table 400 indicates that all of these different user identifiers are associated with a same user and/or device. Likewise, rows 445 and 450 are assigned to the same global user identifier GUID_2, and show that two other user identifiers are commonly linked. (Note that a global user identifier may be any value unique to personalization server 130, in various embodiments).

Before storing correlation information in correlation table 400, a determination is made that two or more user identifiers match one another, in various embodiments. Determining that two or more user identifiers match one another may be done in a variety of ways.

In one example of determining that two user identifiers match one another, data collection module 220 may provide first information indicating a user has logged into a merchant website using one identifier. Data collection module 220 may then also provide second information indicating the user is known to correspond to another particular identifier (e.g., a global identifier such as one provided by a digital payment service). Later, another instance of data collection module 220 may be able to link the same user, with yet a third different user identifier on a merchant site, to the same digital payment service identifier. With the digital payment service identifier (or any other suitable identifier) serving as a common link, it can be established that the two different user identifiers from two different merchant sites (such as on rows 420 and 425) should be matched to the same GUID 415 (“GUID_1”, in the example of FIG. 4).

Providing additional detail on this aspect, a user can log into a merchant website using an email address (as one example), and then make a purchase using an online digital payment service such as PAYPAL. In this case, personalization server 130 may be aware of both the email address that is used and another identifier (e.g., PAYPAL identifier) that is unique to the financial ecosystem of the payment service. Indeed, data collection module 220 may be bundled with functionality that allows the user to log into the online digital payment service itself (i.e., data collection module 220 may be included with digital payment service code that enables purchasing and/or transaction completion). Generally, an online digital payment service may be well positioned to capture personalization data in the context of an online payment mechanism, thus allowing a wide array of data to be captured across a number of different data sources. This contrasts with some other existing payment approaches, such as an online merchant simply using a credit card to directly submit a payment request to a credit card payment network (where in such cases, little or no personalization data may be collected and sent to a system such as personalization server 130). Note that data about non-payment activity may also be collected by a service provider in some embodiments.

Additional information not shown may also be present in correlation table 400. Rows 420-450 may include information, for example, indicating known dates and times that a user identifier was used at a particular site (allowing a last known date and time to be determined). Note that all or a portion of correlation table 400, in various embodiments, may be used with or combined with user action table 500 (described below) in personalization database 135.

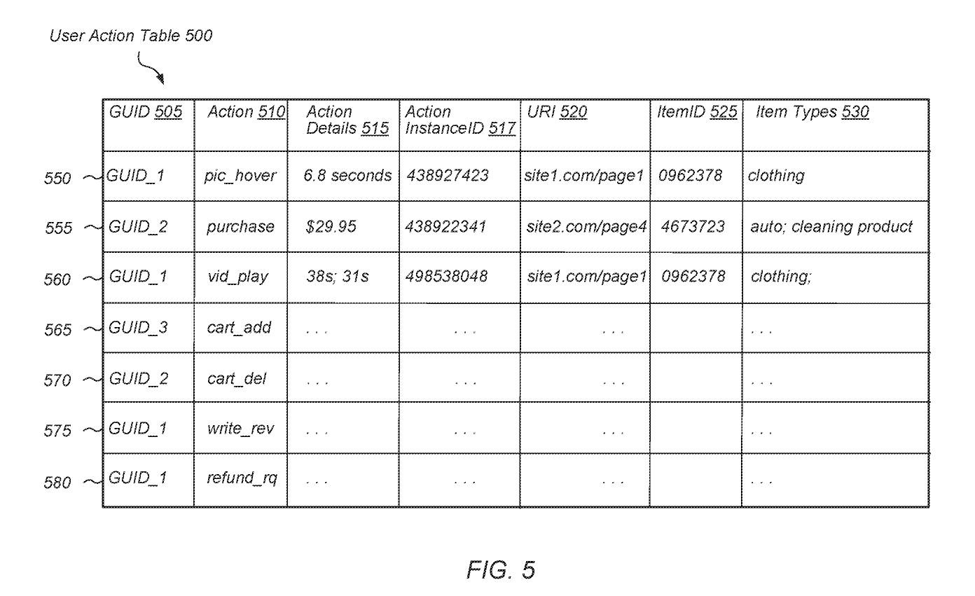

Turning to FIG. 5, a diagram of one embodiment of a user action table 500 is shown. User action table 500 is used to record details regarding user actions taken on a variety of data sources in the embodiment shown. Note that these details regarding user actions taken on data sources may be part of personalization data 140 as stored in correlation database 135, in various embodiments.

User action table 500 includes columns 505, 510, 515, 517 520, 525, and 530 in the embodiment shown. Column GUID 505 corresponds to a global user identifier, which may be the same as GUID 415 from correlation table 400 in various embodiments (thus permitting information in correlation table 400 and user action table 500 to be linked and cross-referenced).

Column Action 510 includes identifiers of different user actions that may be taken on a website. Column ActionDetails 515 includes additional contextual information about one or more particular user actions referenced in Action 510. This contextual information may vary widely in data format and type depending on what type of action is listed in Action 510. Column ActionInstancelD 517 includes a unique identifier, in this embodiment, for each of the actions that is performed by a user. This identifier may be used to distinguish various actions.

URI 520 indicates a particular uniform resource identifier relevant to the user action shown in column 510. ItemID 525 includes an identifier about a particular item (good or service) relevant to the user action from column 510. ItemID 525 may be a value globally unique to personalization server 130, or can be unique to a particular merchant or referenced website (e.g., from URI 520), in various embodiments. In some cases, different formats for ItemID 525 or other data columns may be present in user action table 500 simultaneously; ItemID 525 may also be a UPC (Universal Product Code) in one embodiment. Item Types 530 indicates a broader category into which an item referenced in ItemID 525 falls, and may indicate multiple categories for an item. Note that in some embodiments, any of columns 505-530 may contain multiple data values depending on the particular relational schema used-particularly ActionDetails 515 and Item Types 530.

Below, a further explanation is given of the sample data in user action table 500. In row 550, a user has performed an action of “pic_hover”, indicating the user has hovered over a picture of an item for 6.8 seconds (with their mouse cursor, for example). In another embodiment, a related action could be “pic_view_desktop”, indicating the user had a picture visible on screen for a certain amount of item on a desktop P.C., or “pic_view_mobile”, indicating the user had the picture visible on mobile (which could indicate the user was more likely to actually see the picture, as mobile devices have smaller displays generally and a given picture will generally occupy a relatively larger portion of screen space).

In row 555, a user has made a purchase of an item for $29.95. This item has two categories as shown (auto and cleaning product). Other information for this purchase (not shown) may include date of purchase, type of payment used, shipping option used, delivery address, billing address, etc.

In row 560, a user has played a multimedia video on a web page related to product ItemID 0962378 (the same as from row 550). The video that played was 38 seconds long, however, Action Details 515 for this column indicates the user only watched 31 seconds of the 38 second video. As noted above and herein, a great amount of contextual detail about any user action may be taken and captured via the ActionDetails 515 field.

In row 565, a user has added an item to their cart (“cart_add”), while in row 570, a user has removed an item from their cart (“cart_del”). In row 575, a user has written a review about an item, while in row 580 a user has requested a refund for a previously purchased item. Additional information about these rows is omitted for brevity, but note that many different kinds of action 510 may be present within user action table 500, and are not limited to only those explicitly shown in the embodiment of FIG. 5. Any navigational, browsing, content-consuming, or content-producing action of any kind taken relative to a website can potentially be represented in column action 510 and the other columns and rows of user action table 500 to track user behavior and provide better personalization data. (Note that various actions tracked by user action table 500 may thus be considered “user input actions,” corresponding to instances in which a user has used an input device such as a touchscreen, keyboard, mouse, etc., to interact with an element of a web page.)

Note that in some embodiments, correlation database 135 may utilize other tables to store personalization information 140. In one example, a device action table is used. This device action table may have a GUID for a device and/or user, and store information such as a device's geolocation (coordinates) or other location information, gyroscope information (e.g., tilted 45 degrees, flat, etc.), time of day, and other information associated with a capture of device information. Such device information (assuming user permission is provided of course, in various embodiments) can be used to make inferences about a user's behavior, habits, and preferences. A tilted phone may indicate that the user is reading something or typing something. A phone that is flat and unchanging in location coordinates may indicate that the user sleeps at night at those coordinates (if in the evening) or may indicate that the user has a job that does not allow personal phone use (if in the morning and afternoon, for example). Personalization server 130 can also determine, through personalization data such as device information, that a user reads on her phone for two hours a day vs. five minutes a day for another user; that a user takes twenty pictures a day on average vs. 0.8 pictures a day for another user. Geolocation data can also be used to correlate user real-world actions to merchants. Phone data could indicate a user at a shopping mall spent 45 minutes in a sporting goods store and 22 minutes in an electronics store, for example. This data can be used to infer user interests and allow for greater personalization of website and application content. A device action table, along with a device finger print table (where various device information identifies devices uniquely) may also allow quick reactions in some embodiments in situations such as a live concert or a live exhibition, where dynamic events occur. A user could be presented with particular personalized content based on their geolocation and a dynamic live event for example.

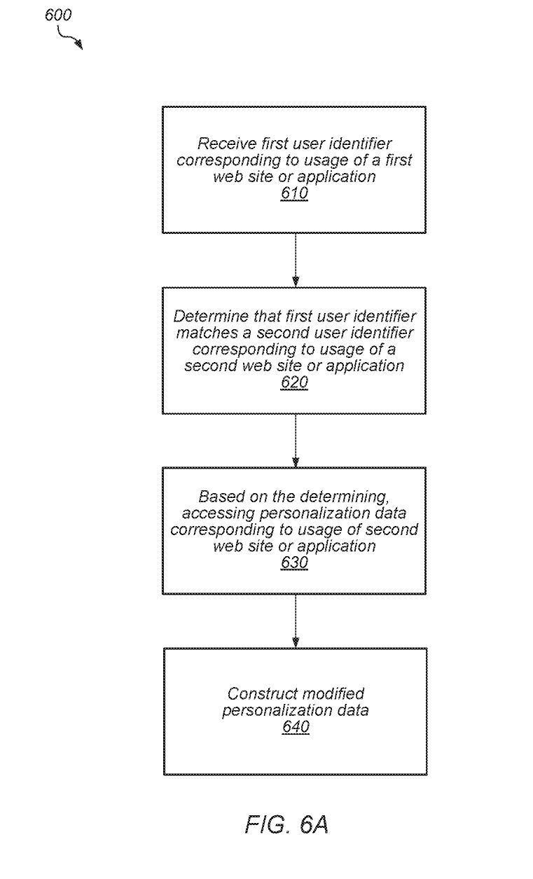

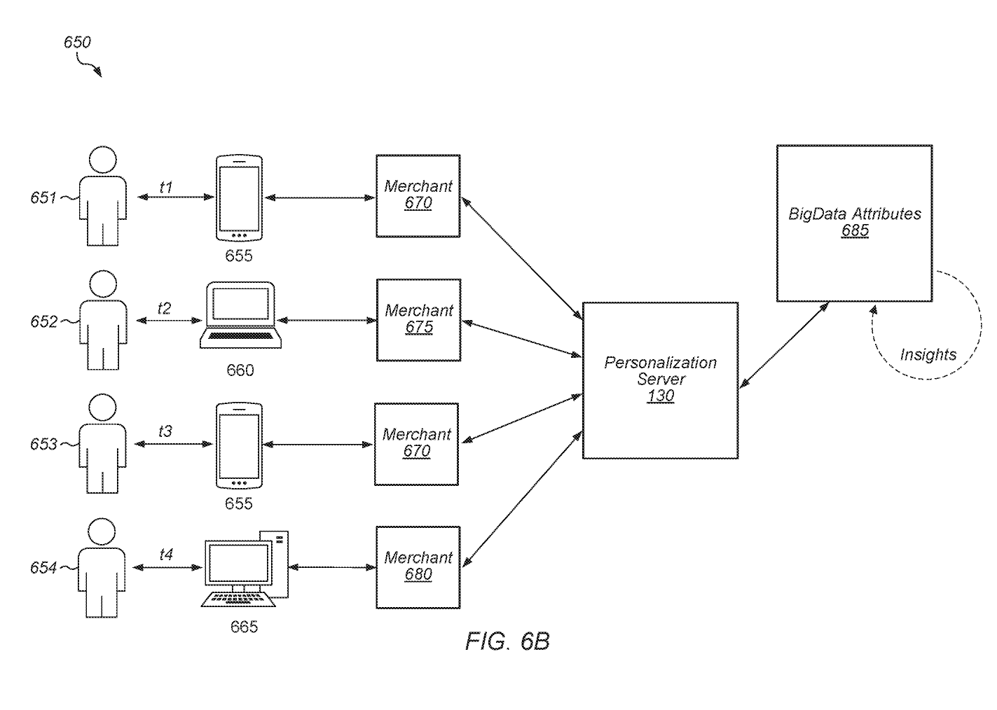

Turning to FIG. 6A, a flow diagram of one embodiment of a method 600 is shown. Each operation of method 600 may be performed by personalization server 130, or any other suitable computer system, in various embodiments. For ease of explanation, however, operations are described below relative to personalization server 130.

In operation 610, personalization server 130 receives a first user identifier corresponding to usage of a first website of a first merchant. (Note: in some embodiments, operation 610 includes receiving a first user identifier from another data source, such as a mobile application, a voice-activated shopping application, a smart appliance or other device with an interface enabling purchases, etc. In general, any aspect of the operations of FIG. 6A may be implemented relative to other applications beyond websites, which are only one contemplated data source with which method 600 may be used. Thus, in one embodiment, operation 610 could include receiving a user identifier from a mobile application, and operation 620 could include determining that the user identifier matches a second user identifier corresponding to usage of a smart appliance. Data sources can be mixed and matched accordingly with the operations of FIG. 6A, in various embodiments.)

For operation 610, this first user identifier may be an email address, a username, an identifier provided by an online payment services company such as PAYPAL, or any other information that uniquely identifies (to the first website) a user and/or a user device, in various embodiments. Thus, the first user identifier could be “firstname.lastname@domain.com”, even if that same email address is used as a user identifier on a different website (however, no other user on the first website could have that identifier, in this embodiment).

User identifiers, as discussed herein, can also include a device fingerprint. This device fingerprint can be assembled from a variety of device and/or network information that may be available to a computer system such as personalization server 130. For example, a user device fingerprint may be based on a combination of information such as operating system type and version, media access control (MAC) address, IP address, processor type, device type, etc. Thus, the first user identifier in operation 610 may also be of any of the formats shown in the UserID column 405 of correlation table 400.

In operation 620, personalization server 130 determines that the first user identifier (from operation 610) matches a second user identifier corresponding to usage of a second website of a second merchant. This matching operation includes, in various embodiments, determining that the two user identifiers correspond to a same individual (or a same device). In particular, a user at one merchant's website (e.g., data source 105) may have a first user identifier (e.g., firstname.lastname@domain.com) on that site, while having a second user identifier (e.g., lastname@differentdomain.com) on another website for a different merchant (e.g., website 110). Matching the two user identifiers together allows for broader correlation of personalization data, in various embodiments, as one merchant who may know nothing about a user can leverage personalization data provided via other merchants who have encountered that user before (even if under a different user identifier).

Payment information, in particular, may form the basis for determining that two user identifiers match one another, in various embodiments. A company that receives a payment authorization request associated with one user identifier can automatically associate a different user identifier based on another payment authorization request corresponding to a same payment account. Thus, a customer who makes purchases via PAYPAL on two different websites, using two different login IDs for those merchant sites, may have those two different login IDs matched together by a same payment account.

Stated another way, using a same digital payment account across multiple different merchant websites (having different user identifiers) can allow those disparate user identifiers to be matched to one another, as it may be possible to see that a same user in the digital payment space is using those different user identifiers across merchant websites. Method 600 can therefore include receiving first and second transaction authorization information respectively corresponding to first and second user identifiers (e.g., payment account information, and merchant website userlDs) and, based on the first and second transaction authorization information corresponding to a same account, storing, in a database, correlation information indicating that the first and second user identifiers correspond to a same entity. Furthermore, note that when determining that first and second user identifiers correspond to a same entity based on first and second transaction authorization information, that transaction authorization information could be from any particular transactions that have occurred in the past (i.e., the transaction authorization information can be for any merchant, and is not limited to the first and second merchants discussed above in the example(s) above).

One embodiment of operation 620 includes determining that a first user identifier matches a second user identifier via accessing correlation information in personalization database 135 using the first user identifier (that is, the first user identifier can be used as an index into the database to locate the second user identifier). Correlation table 400 can be scanned, for example, to determine all user identifiers associated with a same GUID. In one embodiment, this information can be stored in another table for easier access and/or quicker lookup.

In operation 630, personalization server 130 accesses personalization data corresponding to usage of a second website (based on determining that the first user identifier matches a second user identifier, as in operation 620), in one embodiment. Accessing this personalization data may include accessing correlation table 400, user action table 500, or any other personalization data available to personalization server 130. Thus, operation 630 may include accessing information indicative of one or more particular actions taken by a user on the second website.

Operation 640 includes constructing modified personalization data for the first merchant based on the personalization data corresponding to the usage of the second website in the embodiment shown. Constructing modified personalization data may include combining, into a single data set or collection of data, various personalization data gathered from a number of different websites. Thus, modified personalization data for the first merchant may include some or all of the personalization data available from the second merchant and the second website. This modified personalization data could indicate that a user has purchased certain items, or certain types of items, on one or more websites. The modified personalization data may indicate that a user has added items or types of items to a shopping cart in the past. Any aspect of the personalization data discussed above may be used. By constructing modified personalization data in operation 640, a merchant who was unaware of this personalization data may make use of it on their website for web pages that are dynamically configured for a specific user. Note that in one embodiment, a service provider can regulate the frequency of data collection, either upon request by a user or merchant, or by itself.

Constructing modified personalization data may include manipulating existing data and/or making inferences, assumptions, deductions, or estimates to create new data. If personalization data gathered from different sites indicates that a user bought golf balls several times between 12 and 24 months ago, but has not bought any golf balls since, and that the user was observed selling used golf clubs via an auction website, personalization server 130 may conclude that the user has quit the game of golf and no longer plays (or at least that the user is no longer an active player). Modified personalization data could then indicate this fact.

Constructing modified personalization data may include making note of one or more expressed or implied user preferences. One merchant may note that every time a user makes an order over $100, that user requests 1-day express overnight shipping. This information can then be stored in correlation database 135. Another inquiring merchant might be given this fact in the form of modified personalization data, and could then automatically suggest 1-day overnight shipping to that user for a large order. The inquiring merchant could also use this information in other ways, such as generating an offer to the user that for any order over $100, 1-day overnight shipping will be provided free or at a discount. This may encourage the user to make a larger purchase (particularly in view of prior knowledge about the user's shipping preference), thus enabling the inquiring merchant to increase revenue.

Note that in various embodiment, a profile of a user's pre-purchase and post-purchase preferences may be maintained. This data may include shipping preferences, financial preferences (e.g. credit vs. debit), upsell preferences (not wanting extended warranties or services plans vs. opting to participate in such plans), insurance preferences, and offer preferences (e.g., not a frequent purchaser of seasonal offers vs. frequent purchaser of seasonal offers).

Personalization data that was previously unavailable to a merchant may therefore be used in constructing modified personalization data in operation 640 (that is, at least one item of personalization data unavailable to that merchant, and instead gathered from a different source such as a different merchant's website, may be used). By collecting personalization data in a central location, personalization server 130 can leverage information from small and mid-sized merchant websites that might have previously been too fragmented (or simply too difficult to collect) to provide expanded data-sharing opportunities.

Transaction data, as noted above, may be part of personalization data stored by personalization server 130 and used in method 600. Such transaction data may include a variety of transaction details regarding past purchases that users have participated in, in various embodiments. These details may include but are not limited to purchase amount, purchase location, descriptive information about item(s) purchased (cost, UPC, technical specifications relating to physical product characteristics or dimensions and/or technical specifications relating to internal electric or electronic configurations), location of service(s) purchased, merchant identifying information, merchant category code, identifying information of one or more individuals associated with a past transaction (e.g., other names on a travel or hotel itinerary), etc. Further, in cases where transaction data includes transaction details regarding purchases that several users have participated in, the transaction data may be anonymized (e.g. stripped of identifying markers) in various cases so as not to expose identifying information of other users. As one example of anonymizing, data indicating a person bought Kashi cereal might be expressed as “organic food lover.” A buyer of a particular non-GMO (genetically modified) food might be classified as environmentally conscious, or a buyer of a Tesla car might be classified/anonymized merely as a driver of an electric car. In some cases, this transaction data may also be aggregated to further avoid exposing identifying personal information. In one embodiment, transaction data may be sourced from any available party willing to share or provide the data (per any applicable user consent needed).

Method 600 may include transmitting modified personalization data to a variety of different parties, such as the first merchant, the second merchant, or a third merchant, in response to receiving a personalization data request. Thus, a user may have previously visited a second merchant's website, and be currently browsing merchandise on a first merchant's website. The first merchant can then get modified personalization data about the user based on their prior usage of the second merchant's site. A third merchant, in the future, could also receive this same modified personalization data (or the data could be further modified based on additional information).

Method 600 may further include personalization server 130 receiving data regarding inventory offered for sale by a first merchant, in some embodiments. In such embodiments, constructing modified personalization data in operation 640 may be based on this inventory data. For example, if a first merchant sells only expensive men's clothing and jewelry, that merchant may be specifically interested in any personalization data related to its current inventory (rather than other, potentially irrelevant personalization data, in this case, the merchant may not care whether a particular user regularly buys coffee, for example).

### Permissions for Personalization Data

Usage of personalization data can be restricted, in various embodiments, by a user, a merchant, or another entity (such as a legal requirement or a payments provider). A user can be allowed to specify (on a merchant site, or a website associated with personalization server 130) which of her data can be shared and with whom. The user may specify that some data can be shared, some data can only be shared anonymously or pseudo-anonymously (e.g., without an explicit user identifier attached), or that some data cannot be shared at all with any other party than a merchant who originally obtained the data.

A merchant can likewise set permissions on personalization data that it provides to personalization server 130 (either directly or indirectly, through a user). A merchant may not wish for competitors in its same industry or merchant category code, for example, to be able to use the personalization data that it has gathered. Permissions can also be geographically based-a merchant might allow other merchants to use certain personalization data only if they are outside of a given geographic area (e.g., a one hundred mile radius of a location, or outside of a particular state or country), but otherwise not permit usage, or add additional terms or restrictions on personalization data. One merchant could allow anyone to use its personalization data without restriction, while another merchant might require that any such data shared with other merchants be anonymized. Personalization server 130 may thus receive permission data regarding personalization data 140 from a user, a merchant, or other entity.

In accordance with the above, consent is explicitly collected from users for the use of their personalization data, much like any loyalty program does today, in various embodiments. Consent for usage by third parties may also be explicitly obtained. Also, consent collected once by a first merchant on a first device need not be collected for a second merchant on the same (first) device in various embodiments, depending on particular agreements made by a user. Consent may be device agnostic and across accounts a well.

Note that in one embodiment, a social component for correlation is provided. With the appropriate permissions provided by one or more applicable parties, we can correlation user actions by friends and/or family, e.g., personalization data for a merchant could be provided so the merchant could display text such as “Ann Smith also saw this same item” on a web page or application. In another example a husband might be informed that his spouse had viewed an item and had previously added it to a shopping cart (but had not purchased the item). Such information might increase conversion chances on the item being purchased, as the husband could infer that his spouse was seriously interested in buying the item.

### Applications of Personalization Data

In addition to uses noted above, merchants receiving personalization data from personalization server 130 may use this information in a variety of manners. In one embodiment, a merchant may decide whether to extend an offer for store credit (e.g., a loan), and for how much, to a particular customer based on personalization data. In another embodiment, a merchant may provide shipping options for the customer based on the personalization data. Various personalizations may specifically be placed on a checkout page where a customer is near to completing a transaction (or even immediately after a transaction). Certain add-on items, or related items, could be offered to a customer by a merchant based on the personalization data (e.g., if the customer bought shoes, and the merchant knows the customer likes the color green, the merchant could modify the checkout page to suggest upgrading to a pair of green shoelaces from plain white for $3.99). In general, any content on a checkout page, or any other page, of a merchant website may be modified in view of personalization information that is provided to the merchant, allowing for a more dynamic and fulfilling user experience. Shipping, insurance, warranty details may be affected by use of personalization data, in various cases. Offers of credit or financing (via PayPal or non-PayPal financial products) may be predicted and/or based on personalization information in some embodiments as well.

### Use-Case Scenario for Personalization Data

Turning to FIG. 6B, a block diagram is shown illustrating an example of how personalization data can be determined and applied, according to one or more examples. In this figure, person 651 communicates with merchant 670 at time t1 via device 655. The communication can be a purchase, browsing an application or website, etc. Merchant 670 may then share gathered personalization data with personalization server 130. This data may be stored in a database such as BigData Attributes 685 (which can have some or all or the same features as correlation database 135 in various embodiments, and vice versa). Likewise, in this embodiment, person 652 communicates with merchant 675 at time t2 via device 660. While merchant 675 and 670 (and devices 660 and 655) are different in this embodiment, person 652 is the same as person 651 in this example. Merchant 675 may learn that although person 652 is on a different device 660, s/he shares a same home address with person 651. Using this and/or other factors, personalization server 130 may deduce (using insights provided via BigData Attributes 685) that person 652 and 651 are, in fact, the same. Thus, in one example, personalization server 130 could infer that person 651 (and person 652) is a male, age 38, married family of four with two kids, suburban yuppie, searching for a user car ($5k-$10k), new job of two months, and a FICO credit score in the 600-650 range.

At time t3, person 653 communicates with merchant 670 at time t2 via device 655 (the same device used by person 651 earlier). Person 653 could be anyone and thus merchant 675 may inquire to personalization server 130 to ask if the server knows anything about this person. Personalization server 130 could determine that there is an 80% likelihood (or another number) that person 653 is either the same as person 651 (and 652 in this example) or that person 653 is a member of person 651's immediate family. This inference could be based on the same use of the same device 670 and/or other personalization and/or usage data. Personalization information could then be provided to merchant 670 on this basis (e.g., if person 651's family is determined to be upper-middle class, living in an urban area, and owns three vehicles, etc., content could be customized by merchant 670 on the basis of such information).

At yet later time t4, person 654 communicates with merchant 680 via device 665. Person 654 may be different and unrelated to persons 651 (and 652) and 653. However, personalization server 130 may have (or may receive concurrently from merchant 680) certain detailed personalization information about person 654. Using BigData Attributes 685, insight can be made by personalization server 130 using data not just from person 654 but from other persons as well. Thus, personalization server could first determine person 654 is lower middle-class, lives in a suburban area of a mid-sized Midwestern U.S. city, and drives a pickup truck (for example). Based on this information, personalization server 654 could then look up information about other users that are known to have one or more of these attributes (lower middle-class, mid-sized Midwest city, pickup truck), and then make further inferences about person 654. For example, if 70% of people who live in Midwest cities and drive pickup trucks prefer to buy U.S. domestically manufactured products (as opposed to imported products), merchant 680 may be able to more prominently display an offer for a U.S. made product to person 654 on a web page or application screen. Merchant 680 could even augment the offer for the product to include additional text, graphics, or video emphasizing the U.S. manufactured nature of the product—possibly leading to higher conversion of person 654 on the offer. All this may be possible even though neither merchant 680 nor personalization server 130 has particular purchase data about whether person 654 actually has a preference for U.S. made goods. This is just one example, of course, and many many other possible inferences can be made in various embodiments and used to help provide personalization data.

### Computer-Readable Medium

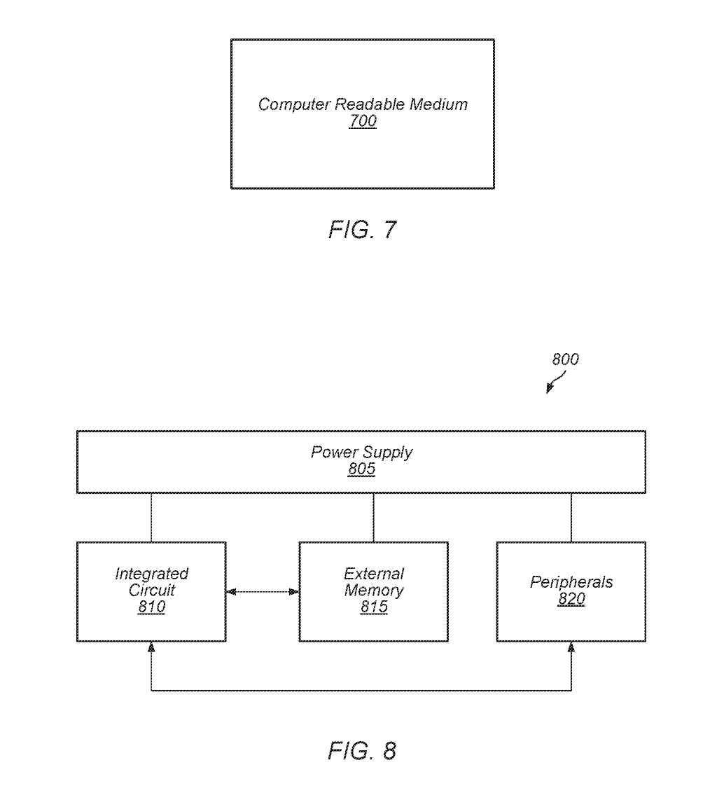

Turning briefly to FIG. 7, a block diagram of one embodiment of a computer-readable medium 700 is shown. This computer-readable medium may store instructions corresponding to the operations of FIG. 6A and/or any techniques described herein. The program instructions may be stored on a non-volatile medium such as a hard disk or FLASH drive, or may be stored in any other volatile or non-volatile memory medium or device as is well known, such as a ROM or RAM, or provided on any media capable of staring program code, such as a compact disk (CD) medium, DVD medium, holographic storage, networked storage, etc. Additionally, the entire program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a server or server system such as, for example, in C, C+, HTML, Java, JavaScript, or any other scripting language, such as VBScript. Note that as used herein, the term “computer-readable medium” refers to a non-transitory computer readable medium.

### Computer System

In FIG. 8, one embodiment of a computer system 800 is illustrated. Various embodiments of this system may be a user system, merchant system, a server system, or any other computer system as discussed above and herein.

In the illustrated embodiment, system 800 includes at least one instance of an integrated circuit (processor) 810 coupled to an external memory 815. The external memory 815 may form a main memory subsystem in one embodiment. The integrated circuit 810 is coupled to one or more peripherals 820 and the external memory 815. A power supply 805 is also provided which supplies one or more supply voltages to the integrated circuit 810 as well as one or more supply voltages to the memory 815 and/or the peripherals 820. In some embodiments, more than one instance of the integrated circuit 810 may be included (and more than one external memory 815 may be included as well).

The memory 815 may be any type of memory, such as dynamic random access memory (DRAM), synchronous DRAM (SDRAM), double data rate (DDR, DDR2, DDR6, etc.) SDRAM (including mobile versions of the SDRAMs such as mDDR6, etc., and/or low power versions of the SDRAMs such as LPDDR2, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit 810 in a chip-on-chip configuration, a package-on-package configuration, or a multi-chip module configuration.

The peripherals 820 may include any desired circuitry, depending on the type of system 800. For example, in one embodiment, the system 800 may be a mobile device (e.g. personal digital assistant (PDA), smart phone, etc.) and the peripherals 820 may include devices for various types of wireless communication, such as wifi, Bluetooth, cellular, global positioning system, etc. The peripherals 820 may also include additional storage, including RAM storage, solid state storage, or disk storage. The peripherals 820 may include user interface devices such as a display screen, including touch display screens or multitouch display screens, keyboard or other input devices, microphones, speakers, etc. In other embodiments, the system 800 may be any type of computing system (e.g. desktop personal computer, server, laptop, workstation, net top etc.). Peripherals 820 may thus include any networking or communication devices necessary to interface two computer systems.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed by various described embodiments. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
receiving, by a computer system, a first user identifier corresponding to usage of a first website of a first merchant;
determining, by the computer system, that the first user identifier matches a second user identifier corresponding to usage of a second website of a second merchant;
based on the determining, the computer system accessing personalization data corresponding to the usage of the second website; and
the computer system constructing modified personalization data for the first merchant based on the personalization data corresponding to the usage of the second website.

2. The method of claim 1, further comprising the computer system:
receiving first and second transaction authorization information respectively corresponding to the first and second user identifiers; and
based on the first and second transaction authorization information corresponding to a same account, storing, in a database, correlation information indicating that the first and second user identifiers correspond to a same entity.

3. The method of claim 2, wherein determining that the first user identifier matches the second user identifier includes accessing the correlation information in the database using the first user identifier.

4. The method of claim 2, wherein the first and second transaction authorization information each includes payment account identification information corresponding to a particular payment account of a user.

5. The method of claim 1, wherein constructing the modified personalization data comprises creating a data set including at least one item of personalization data that was unavailable to the first merchant prior to the constructing.

6. The method of claim 1, further comprising the computer system transmitting the modified personalization data to at least one of the first merchant, the second merchant, or a third merchant in response to receiving a personalization data request.

7. The method of claim 1, wherein the personalization data includes usage data indicative of one or more particular actions taken by a user on the first website.

8. The method of claim 7, wherein the one or more particular actions include at least one of adding an item to a shopping cart, hovering a cursor above a picture or description of an item, or removing an item from the shopping cart.

9. The method of claim 1, wherein the personalization data includes a user-provided preference regarding a type of goods or services sold by at least one of the first merchant or the second merchant.

10. The method of claim 1, wherein the personalization data includes at least one of a location associated with a user, information regarding one or more other household members associated with the user, or information regarding one or more purchases made by the user on the first website.

11. The method of claim 1, wherein the first user identifier is issued by a computer server corresponding to a financial payment service, and wherein the first user identifier is used by the first merchant as part of a payment authorization request.

12. A non-transitory computer-readable medium having stored thereon instructions that are executable to cause a computer system to perform operations comprising:
receiving a first user identifier corresponding to usage of a first website of a first merchant;
determining that the first user identifier matches a second user identifier corresponding to usage of a second website of a second merchant;
based on the determining, accessing first personalization data indicating one or more particular user actions taken relative to one or more particular goods or services offered for sale via the second website; and
constructing modified personalization data for the first merchant based on the first personalization data.

13. The non-transitory computer-readable medium of claim 12, wherein the operations further comprise receiving data regarding inventory offered for sale by the first merchant; and
transmitting the modified personalization data to the first merchant in response to a request from the first merchant;
wherein the modified personalization data includes data pertaining to at least one item of the inventory offered for sale by the first merchant.

14. The non-transitory computer-readable medium of claim 12, wherein constructing the modified personalization data is based on anonymized personalization data obtained regarding usage of a plurality of websites by a plurality of users.

15. The non-transitory computer-readable medium of claim 12, wherein the one or more particular user actions comprise adding the one or more particular goods or services to an online shopping cart.

16. The non-transitory computer-readable medium of claim 12, wherein the one or more particular user actions comprise taking one or more user input actions relative to a web page element on the second website of the second merchant.

17. A system, comprising:
a processor, and
a non-transitory computer-readable medium having stored thereon instructions that are executable by the processor to cause the system to perform operations comprising:
receiving, by a computer system, a first user identifier corresponding to usage of a first website of a first merchant;
determining, by the computer system, that the first user identifier matches a second user identifier corresponding to usage of a second website of a second merchant;
based on the determining, the computer system accessing first personalization data corresponding to the usage of the second website and second personalization data corresponding to usage of a third website of a third merchant; and
the computer system constructing modified personalization data for the first merchant based on the first personalization data and the second personalization data.

18. The system of claim 17, wherein the determining that the first user identifier matches the second user identifier as based on previous usage of the second user identifier with a digital payments account that is also associated with the first user identifier.

19. The system of claim 17, wherein the operations further comprise receiving permission data, from the second merchant, indicating which portions of the first personalization data are permitted to be shared with the first merchant.

20. The system of claim 19, wherein the first personalization data is indicative of one or more particular actions taken by a user on the second website, and wherein the second personalization data is indicative of one or more particular actions taken by a user on the third website.
